(19) United States
(12) Patent Application Publication
(10) Pub. No.: US 2015/0120372 A1
(43) Pub. Date: Apr. 30, 2015

(54) ELECTRIC POWER CONTROL DEVICE, ELECTRIC POWER CONTROL METHOD, AND COMPUTER PROGRAM STORAGE MEDIUM

(71) Applicant: NEC CORPORATION, Tokyo (JP)

(72) Inventor: Takayuki Shizuno, Tokyo (JP)

(73) Assignee: NEC Corporation, Tokyo (JP)

(21) Appl. No.: 14/399,703

(22) PCT Filed: May 13, 2013
(86) PCT No.: PCT/JP2013/003055

§ 371 Date: Nov. 7, 2014

(30) Foreign Application Priority Data
May 18, 2012 (JP) 2012-114486

(51) Int. Cl. G06Q 10/06; B60L 11/18

(52) U.S. Cl. CPC G06Q 10/06315; B60L 11/1848; B60L 11/1846; B60L 11/184
USPC 705/7.25

(57) ABSTRACT

An electric power control device includes an electric power control policy storage unit which stores an electric power control policy in which the maximum electric power consumption of a charger is determined according to a customer rank indicating a degree of priority of a customer and an electric power unit price specified by a time zone, a customer identification information acquisition unit which acquires customer identification information of the customer which requests the use of the charging service, a customer rank determination unit which determines the customer rank based on customer information of the customer, and an electric power control unit which controls the maximum electric power consumption of the charger when providing the charging service to the customer based on the electric power unit price in a time zone in which the charging service is provided to the customer, the customer rank, and the electric power control policy.

### TECHNICAL FIELD

The present invention relates to a technical field of an electric power control device which controls an electric power consumption in a charging system or the like.

### BACKGROUND ART

In recent years, an electric vehicle which travels by the driving force of an electric motor is being developed. Such electric vehicle has a storage battery which drives the electric motor. When such electric vehicle travels, an electricity storage amount stored in the storage battery decreases and the storage battery needs to be charged by a rapid charging system installed at a service station, a shopping center, or the like or a charging facility installed in a user's home garage or the like.

On the other hand, there is a technology called Community Energy Management System (CEMS) which manages an electric power consumed in an area. Generally, the CEMS monitors the electric power consumed in the area and performs a control so that the electric power consumed in the area is suppressed when it is expected that the electric power supply will be tight. The CEMS performs a control so that the electric power consumed in the area increases when it is expected that the electric power is excessively supplied and will be wasteful. As one of the methods for controlling the electric power consumed in the area, a Demand Response (DR) method by which the electric power in the area is indirectly controlled by dynamically changing the electricity charges is used. Generally, when the DR method is used, when it is expected that the electric power supply will be tight, the electricity charges are increased and when it is expected that the electric power is excessively supplied and will be wasteful, the electricity charges are reduced. A consumer (customer) which consumes the electric power does not want to use expensive electricity and wants to use inexpensive electricity. Therefore, the CEMS can indirectly control the electric power consumed in the area by using the DR method.

Here, the rapid charging system installed at the service station, the shopping center, or the like consumes a large amount of electric power. Therefore, it is expected that the CEMS contributes to the reduction of the electric power consumed by the rapid charging system. Further, when a provider of a charging service (hereinafter, described as a charging service provider) uses a charging system using the DR method, there is a possibility that it can contribute to the electric power management in the area and the electricity charges can be reduced.

One example of a technology in which an electric power consumption of an object device is controlled by using such DR method is described in patent literature 1. The electric power control device described in patent literature 1 is a device which controls the electric power consumption of a home electrical appliance. This electric power control device issues a control command to various home electrical appliances based on a DR signal received from an outside so as to reduce the electric power consumption in a time zone in which the electricity charges are high. The electric power control device reduces the electric power consumption in the time zone in which the electricity charges are high by issuing the control command.

Further, an example of a technology in which the electric power supplied to each of the storage batteries mounted on a plurality of electric vehicles is controlled is described in patent literature 2. The electric power control device described in patent literature 2 ranks a plurality of electric vehicles that are the charged objects charged simultaneously based on information indicating a vehicle type such as a vehicle for private use or the like. In the invention disclosed in patent literature 2, a plurality of the electric vehicles that are the charged objects are an emergency vehicle, a vehicle for high public use, a vehicle for business, and the like. When the electric power control device charges the storage batteries mounted on the plurality of electric vehicles simultaneously, the electric power control device controls the electric power supplied to each storage buttery based on the rank of the electric vehicle that is the charged object. As a result, this electric power control device prevents an integrated value of the electric power required for simultaneously charging all the storage batteries mounted on the plurality of electric vehicles from exceeding the maximum available electric power.

Further, an example of a technology for controlling the electric power required for charging the storage batteries mounted on the electric vehicles which travel in the area is described in patent literature 3. The electric power control device described in patent literature 3 invites the electric vehicle travelling in the area which wants to be charged at a charging station in the area. The electric power control device ranks the electric vehicle which wants to be charged by an index using a user-acceptable unit price for charging and a remaining battery level. This electric power control device distributes the total electric power for charging that is distributable to a group of the charging stations in the area to a pair of each electric vehicle and the charging station to which the electric vehicle is guided based on the rank.

### CITATION LIST

### Patent Literature

PTL 1: Japanese Patent Application Laid-Open No. 2011-142753
PTL 2: Japanese Patent Application Laid-Open No. 2010-110173
PTL 3: Japanese Patent Application Laid-Open No. 2012-48286

### SUMMARY OF INVENTION

### Technical Problem

However, the technologies disclosed in patent literature 1 to patent literature 3 mentioned above have a problem in which satisfaction of a charging service provider and satisfaction of a customer which uses the charging service cannot be improved simultaneously. The reason will be described below.

When the electric power control device described in patent literature 1 is applied to a charging system for the electric vehicle, the electric power control device reduces the electric power consumption of the charging system in the time zone in which the electricity charges are high based on the DR signal received from the outside. Accordingly, the technology described in this patent literature 1 can reduce the electricity charges and improve the satisfaction of the charging service provider. However, when the electric power consumption of the charging system is reduced, a charging time for charging the storage battery mounted on the electric vehicle increases. Accordingly, the satisfaction of the customer using the charging system decreases. In particular, an advantageous effect of the rapid charging system in which the charging can be performed in a short time decreases.

Further, the electric power control device described in patent literature 2 controls the electric power for charging according to the rank determined based on urgency, publicness, and the like of the electric vehicle that is the charged object. Accordingly, the satisfaction of the customer which uses the charging service can be improved according to the rank. However, the electric power control device does not take the electricity charges that are different for each time zone into consideration. Accordingly, there is a case in which the electric power control device cannot suppress the electric power consumption of the charging system in the time zone in which the electricity charges are high. In this case, the satisfaction of the charging service provider decreases.

The electric power control device described in patent literature 3 distributes the electric power for charging to each electric vehicle according to the rank based on the user-acceptable unit price for charging and the remaining battery level. Accordingly, this electric power control device improves the satisfaction of the customer which uses the charging service. Further, this electric power control device distributes the total electric power for charging that is distributable in the area and thereby, contributes to the power management in the area. However, this electric power control device does not take the electricity charges that are different for each time zone into consideration. Therefore, there is a case in which this electric power control device cannot suppress the electric power consumption of the charging system in the time zone in which the electricity charges are high at the certain charging station and whereby, the satisfaction of the charging service provider decreases.

One object of the present invention is to provide a technology in which the satisfaction of the charging service provider and the satisfaction of the customer can be improved simultaneously in order to solve the above-mentioned problem.

### Solution to Problem

An electric power control device according to the invention includes: an electric power control policy storage unit which stores an electric power control policy in which the maximum electric power consumption of a charger is determined according to a customer rank indicating a degree of priority of a customer which uses a charging service in which a storage battery is charged by the charger and an electric power unit price specified by a time zone; a customer identification information acquisition unit which acquires customer identification information by which the customer which requests the use of the charging service is identified; a customer rank determination unit which determines the customer rank of the customer based on customer information about the customer identified by the customer identification information; and an electric power control unit which controls the maximum electric power consumption of the charger when providing the charging service to the customer based on the electric power unit price in the time zone in which the charging service is provided to the customer identified by the customer identification information, the customer rank of the customer identified by the customer identification information, and the electric power control policy.

A charging system according to the invention includes: the electric power control device; and a charger which charges the storage battery while variably controlling the maximum electric power consumption according to the control of the electric power control device.

An electric power control method according to the invention includes: storing an electric power control policy in which the maximum electric power consumption of a charger is determined according to a customer rank indicating a degree of priority of a customer which uses a charging service in which a storage battery is charged by a charger and an electric power unit price specified by a time zone; acquiring customer identification information by which the customer which requests the use of the charging service is identified; determining the customer rank of the customer based on customer information about the customer identified by the customer identification information; and controlling the maximum electric power consumption of the charger when providing the charging service to the customer based on the electric power unit price in the time zone in which the charging service is provided to the customer identified by the customer identification information, the customer rank of the customer identified by the customer identification information, and the electric power control policy.

A computer program according to the invention allows a computer device to perform: by using an electric power control policy storage unit which stores an electric power control policy in which the maximum electric power consumption of a charger is determined according to a customer rank indicating a degree of priority of a customer which uses a charging service in which a storage battery is charged by the charger and an electric power unit price specified by a time zone, a customer identification information acquisition step acquiring customer identification information by which the customer which requests the use of the charging service is identified; a customer rank determination step determining the customer rank of the customer based on customer information about the customer identified by the customer identification information; and an electric power control step controlling the maximum electric power consumption of the charger when providing the charging service to the customer based on the electric power unit price in the time zone in which the charging service is provided to the customer identified by the customer identification information, the customer rank of the customer identified by the customer identification information, and the electric power control policy.

Further, the object of the present invention can be realized by a computer-readable non-transitory storage medium storing the computer program.

### Advantageous Effects of Invention

The present invention can provide the technology in which when the charging service is used, the satisfaction of the charging service provider and the satisfaction of the customer can be improved simultaneously.

### BRIEF DESCRIPTION OF DRAWINGS

FIG. 1 is a block diagram illustrating a configuration of a charging system according to a first exemplary embodiment of the present invention.

FIG. 2 is a functional block diagram of a charger according to the first exemplary embodiment of the present invention.

FIG. 3 is a functional block diagram of an electric power control device according to the first exemplary embodiment of the present invention.

FIG. 4 is a figure for explaining an example of information stored in a customer information storage unit according to the first exemplary embodiment of the present invention.

FIG. 5 is a figure for explaining an example of an electric power control policy in the first exemplary embodiment of the present invention.

FIG. 6 is a flowchart for explaining operation of a charging system according to the first exemplary embodiment of the present invention.

FIG. 7 is a block diagram illustrating a configuration of an electric power control device according to a second exemplary embodiment of the present invention.

FIG. 8 is a flowchart for explaining operation of an electric power control device according to the second exemplary embodiment of the present invention.

FIG. 9 is a block diagram illustrating a hardware configuration of a computer which can realize an electric power control device according to each exemplary embodiment of the present invention as an example.

### DESCRIPTION OF EMBODIMENTS

Hereinafter, each exemplary embodiment of the present invention will be described in detail with reference to the drawing.

### First Exemplary Embodiment

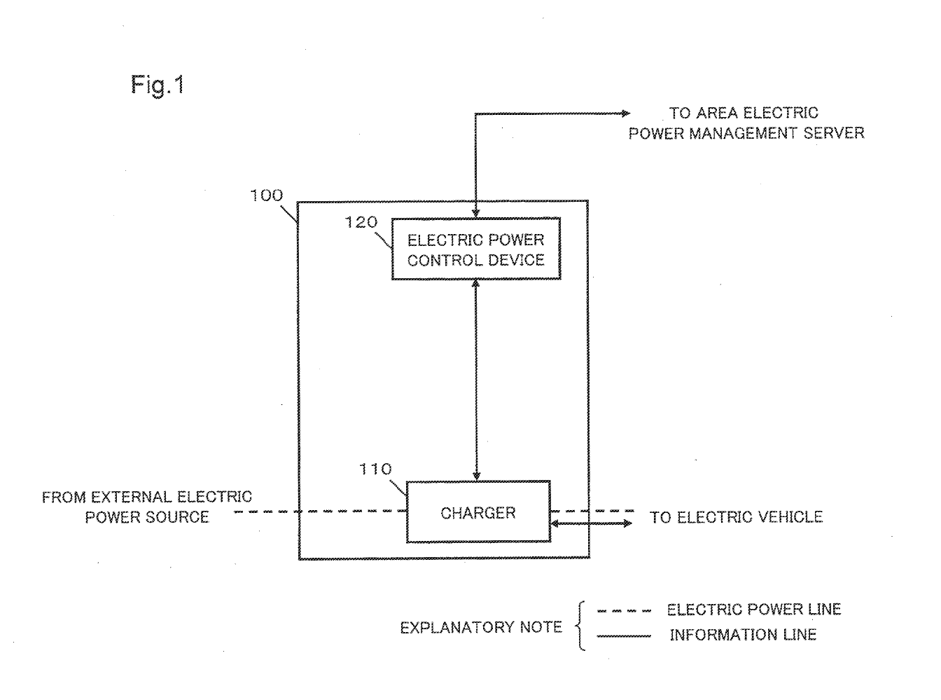

First, a block diagram illustrating a configuration of a charging system 100 according to a first exemplary embodiment of the present invention is illustrated in FIG. 1. In FIG. 1, the charging system 100 includes a charger 110 and an electric power control device 120. The charger 110 is connected to an external electric power source which supplies the electric power to a storage battery that is a charged object. The charger 110 connected to the external electric power source is connected to the electric vehicle on which the storage battery that is the charged object is mounted via an electric power line and an information line. The charger 110 and the electric power control device 120 are connected so as to be communicable with each other. Further, the electric power control device 120 is connected to an area electric power management server via a communication network (hereinafter, referred to as “network”) composed of the Internet, a LAN (Local Area Network), a public line network, a wireless communication network, or a combination of these networks. Here, the area electric power management server is a server apparatus which performs supervisory control of the electric power consumed in the area and a server apparatus which transmits a DR (Demand Response) signal to a consumer including the charging system 100. The DR signal includes information indicating the electric power charge (electric power unit price) for each time zone. Further, the charging system 100 illustrated in FIG. 1 includes one charger and one electric power control device. However, the number of the chargers and the number of the electric power control devices included in the charging system are not limited to one.

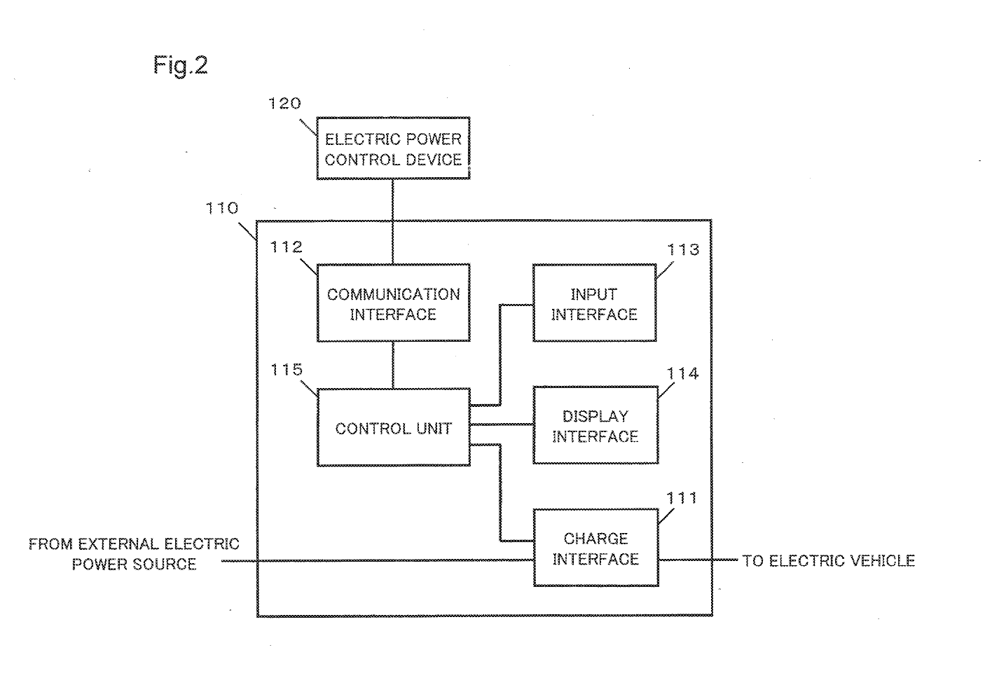

First, a configuration of the charger 110 according to the exemplary embodiment is illustrated in FIG. 2. In FIG. 2, the charger 110 includes a charge interface 111, a communication interface 112, an input interface 113, a display interface 114, and a control unit 115.

The charge interface 111 supplies the electric power acquired from the external power supply to the storage battery mounted on the electric vehicle by a cable for charging or the like connecting between the charge interface 111 and the electric vehicle. Further, the charge interface 111 transmits/receives information to/from the electric vehicle via the cable for charging or the like. The cable for charging (not shown) which connects between such charge interface 111 and the electric vehicle includes an electric power line and an information line. For example, the information that is transmitted by the electric vehicle and received by the charge interface 111 includes information of an electric power required by the electric vehicle and an amount of electric power.

The communication interface 112 transmits/receives information about charging to/from the electric power control device 120. The information transmitted to the electric power control device 120 from the communication interface 112 is customer identification information which identifies the customer. The information that is transmitted by the electric power control device 120 and received by the communication interface 112 is information of the maximum electric power consumption.

The input interface 113 and the display interface 114 act as a machine interface (user interface (UI)) between the charging system and the customer.

The input interface 113 acquires the customer identification information inputted by the customer which requests the use of the charging system 100. For example, a card reader for an IC (Integrated Circuit) card, a magnetic card, or the like and an operation button act as the input interface 113.

The display interface 114 displays various information displayed for the customer which uses the charging system 100. For example, a liquid crystal display acts as the display interface 114.

The control unit 115 in the charger 110 is composed of a CPU (Central Processing Unit), a RAM (Random Access Memory), a ROM (Read Only Memory), and a storage device. The control unit 115 reads a computer program stored in the ROM or the storage device, stores it in the RAM, and executes it to control all the sections of the charger 110.

Specifically, the control unit 115 in the charger 110 notifies the electric power control device 120 of the customer identification information inputted to the input interface 113 via the communication interface 112. Further, the storage battery mounted on the electric vehicle is charged by controlling the charge interface 111 by the control unit 115 so as not to exceed the maximum electric power consumption based on the information transmitted from the electric power control device 120 via the communication interface 112.

Further, the control unit 115 may calculate a time at which the charging of the storage battery mounted on the electric vehicle ends based on information of the electric power required for the electric vehicle, the amount of electric power, and the like and the maximum electric power consumption and display the calculated time in the display interface 114.

Further, the control unit 115 may transmit information indicating a usage situation of the customer to the electric power control device 120 via the communication interface 112 based on a result of the operation of the charge interface 111. For example, the information indicating the usage situation of the customer in the exemplary embodiment may include the customer identification information, information indicating the charged electric power amount, and information indicating a purchase price at that time.

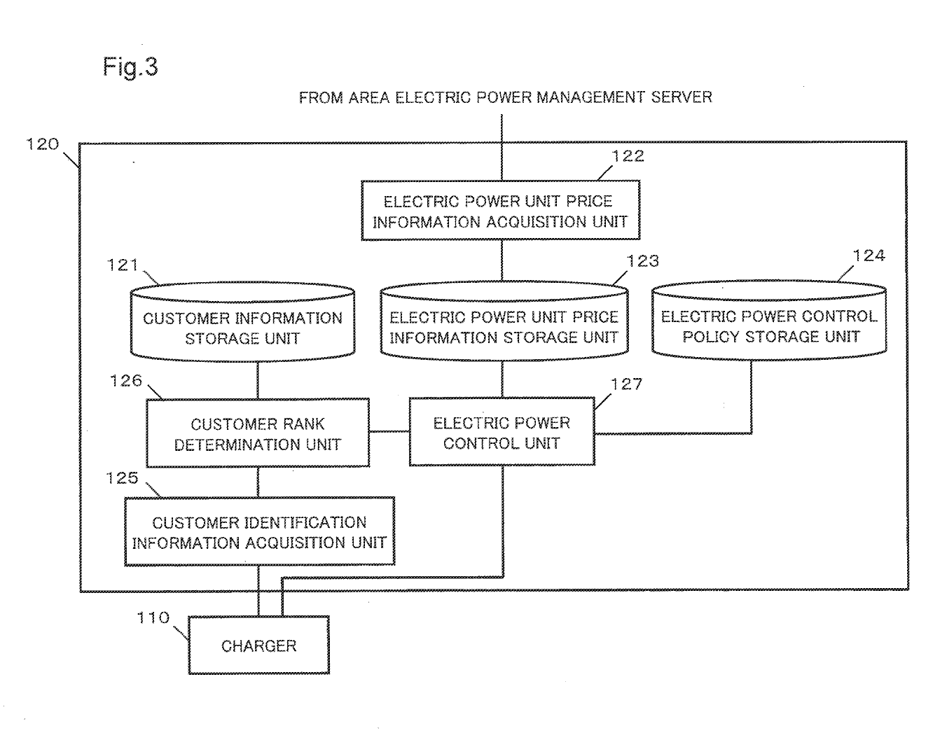

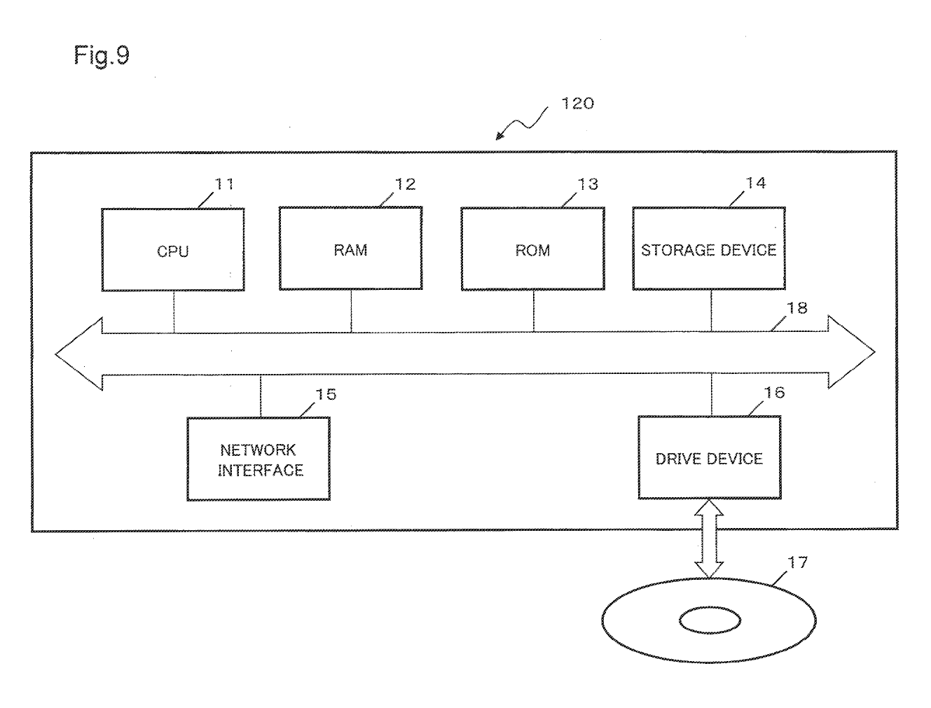

Next, the configuration of the electric power control device 120 is illustrated in FIG. 3. In FIG. 3, the electric power control device 120 includes a customer information storage unit 121, an electric power unit price information acquisition unit 122, an electric power unit price information storage unit 123, an electric power control policy storage unit 124, a customer identification information acquisition unit 125, a customer rank determination unit 126, and an electric power control unit 127. FIG. 9 is a block diagram illustrating a hardware configuration of an information processing device (computer) which can realize the electric power control device 120 as an example. Here, the electric power control device 120 includes a CPU 11, a RAM 12, a ROM 13, a storage device 14 such as a hard disk or the like, a network interface 15, and a drive device 16 by which data can be read from/written to a storage medium 17 such as a CD (compact disk)—ROM. The elements illustrated in FIG. 9 are connected by a bus 17 so as to be communicable with each other. Further, each of the customer information storage unit 121, the electric power unit price information storage unit 123, and the electric power control policy storage unit 124 is composed of the storage device 14. Each of the electric power unit price information acquisition unit 122, the customer identification information acquisition unit 125, and the electric power control unit 127 is composed of the network interface 15 and the CPU 11 which reads a computer program stored in the ROM 13 or the storage device 14, stores it in the RAM 12, and executes it. Further, the customer rank determination unit 126 is composed of the CPU 11 which reads the computer program stored in the ROM 13 or the storage device 14, stores it in the RAM 12, and executes it.

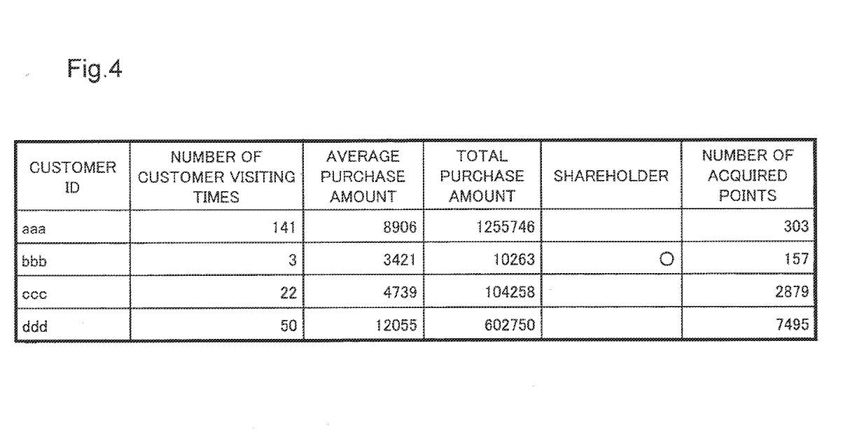

The customer information storage unit 121 stores customer information about a customer of the charging system 100. An example of the information stored in the customer information storage unit 121 according to this exemplary embodiment is illustrated in FIG. 4. In FIG. 4, the customer information is illustrated in each row. In FIG. 4, in the customer information, a customer ID (identifier) by which each customer is identified is associated with information indicating the number of customer visiting times, an average purchase amount, a total purchase amount, a flag of shareholder, and the number of acquired points. The number of customer visiting times in the customer information corresponds to the number of use times of the charging system 100 or the service related to it that has been used by the customer in the past. Here, the service related to the charging system 100 may be various services such as a sale of goods and the like which are provided at a service station at which the charging system 100 is operated or another facility such as a shopping center or the like. For example, the number of customer visiting times may be the number of visiting times to the above-mentioned facility at which the charging system 100 is installed by the customer in the past. The average purchase amount of the customer is an average value of the one-time purchase amounts of the electric power or the goods when the customer uses the charging system 100 or the service related to it. The total purchase amount of the customer is a sum of the purchase prices of the electric power or the goods purchased when the customer uses the charging system 100 or the service related to it. The flag of shareholder is information indicating whether or not the customer holds a share related to the provider of the charging system 100 or the service related to it. The number of acquired points of the customer is the number of points given to the customer by the provider of the charging system 100 and the service related to it. Thus, the customer information may include information indicating a usage situation at the time when the customer used the charging system 100 or the service related to it in the past and the customer information storage unit 121 may store it.

Further, the customer information storage unit 121 updates the customer information based on the usage situation of the customer which used the charging system 100. For example, when the customer information storage unit 121 is notified of the information indicating a new usage situation of the customer from the customer identification information acquisition unit 125 described later, the customer information storage unit 121 may update the customer information.

The electric power unit price information acquisition unit 122 in the electric power control device 120 acquires electric power unit price information including the time zone and an electric power unit price in the time zone. For example, the time zone in which the electric power unit price information is acquired may be a time zone in each day such as 12:00-13:00 or a time zone in a day which satisfies a predetermined condition such as 13:00-14:00 every weekday. Further, for example, the electric power unit price is represented by a price per 1 kwh (Kilo-watt hours). Specifically, the electric power unit price information acquisition unit 122 receives the DR signal transmitted from the area electric power management server and stores the electric power unit price information included in the received DR signal in the electric power unit price information storage unit 123.

The electric power control policy storage unit 124 in the electric power control device 120 stores the electric power control policy. Here, the electric power control policy is information indicating the maximum electric power consumption of the charger 110 determined according to each customer rank and each electric power unit price. Here, the customer rank represents a degree of priority of the customer.

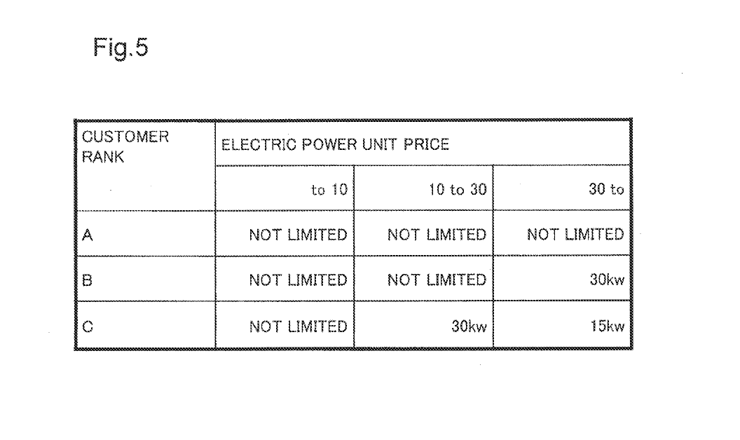

An example of the electric power control policy stored in the electric power control policy storage unit 124 is illustrated in FIG. 5. In the example illustrated in FIG. 5, the customer rank is represented by the alphabets (A to C) and the degree of priority of the customer increases in alphabetical order. In the example of this power control policy, the limitation of the maximum electric power consumption is not set for the customer whose customer rank is “A” independently of a value of the electric power unit price. On the other hand, the limitation of the maximum electric power consumption is not set for the customer whose customer rank is “C” when the electric power unit price is less than 10. However, when the electric power unit price is between 10 and 30, the limitation of the maximum electric power consumption is set to 30 kw for the customer whose customer rank is “C”. And when the electric power unit price is equal to or greater than 30, the limitation of the maximum electric power consumption is set to 15 kw for the customer whose customer rank is “C”. Thus, it is desirable to determine the electric power control policy in which when the electric power unit price is high and the customer rank is low, the maximum electric power consumption of the charger 110 is set to a small value and when the electric power unit price is low and the customer rank is high, the maximum electric power consumption of the charger 110 is set to a large value.

The customer identification information acquisition unit 125 in the electric power control device 120 acquires the customer identification information of the customer which requests the use of the charging system 100 from the charger 110. In other words, the customer identification information acquisition unit 125 acquires the customer identification information inputted by the customer which requests the use of the charging system 100 via the input interface 113 of the charger 110 by connecting between the charge interface 111 of the charger 110 and the electric vehicle. The customer identification information may be the customer ID. Further, when the customer information corresponding to the acquired customer identification information is not stored in the customer information storage unit 121, the customer identification information acquisition unit 125 may generate new customer information in the customer information storage unit 121.

Further, when the customer identification information acquisition unit 125 acquires the information indicating an electricity usage situation of the customer from the charger 110, the customer identification information acquisition unit 125 may update the customer information of the customer concerned.

The customer rank determination unit 126 in the electric power control device 120 determines the customer rank of the customer based on the customer information of the customer identified by the customer identification information. For example, the customer rank determination unit 126 may give a higher rank to the customer whose average purchase amount is large. Further, the customer rank determination unit 126 may give a higher rank to the customer of which the number of customer visiting times is large. Further, the customer rank determination unit 126 may give a higher rank to the customer which is a shareholder as compared to the customer which is not a shareholder. Further, the customer rank determination unit 126 may give a higher rank to the customer having a large number of points.

For example, the customer rank determination unit 126 may set the customer rank of the shareholder to “A” as the best customer. Further, the customer rank determination unit 126 may set the customer rank of the customer of which the total purchase amount of the electric power is equal to or greater than 800,000 yen and the number of customer visiting times to the facility or the like is equal to or greater than 100 to “A” based on the customer information as the best customer like the shareholder. Further, the customer rank determination unit 126 may set the customer rank of the customer which satisfies at least one of the conditions: the total purchase amount of the electric power is equal to or greater than 200,000 yen and less than 800,000 yen, the average purchase amount of the electric power is equal to or greater than 4,000 yen and less than 8,000 yen, and the number of acquired points is equal to or greater than 5,000 points and the condition: the number of customer visiting times to the facility or the like is equal to or greater than 40 and smaller than 100 to “B” based on the customer information. The customer rank determination unit 126 may set the customer rank of the customer which satisfies at least one of the conditions: the total purchase amount of the electric power is less than 200,000 yen, the average purchase amount of the electric power is less than 4000 yen, and the number of customer visiting times to the facility or the like is smaller than 40 to “C” based on the customer information. As a result, in the customer information illustrated in FIG. 4, the degree of priority of the customer is set as follows. The customer rank of the customer with customer ID “aaa” and the customer rank of the customer with customer ID “bbb” are set to “A”. The customer rank of the customer with customer ID “ddd” is set to “B”. The customer rank of the customer with customer ID “ccc” is set to “C”. Thus, it is desirable to determine the degree of priority of the customer in which a degree of good customer to the charging service provider is reflected as the customer rank by the customer rank determination unit 126.

The customer rank determined according to the customer information is differentiated for each time zone by the customer rank determination unit 126. For example, the customer rank determination unit 126 may give a higher rank to the customer of which the number of customer visiting times to the facility or the like is small or a new customer in a predetermined time zone. As a result, the customer rank determination unit 126 can set the customer rank so as to temporarily give preference to the new customer. Further, the customer rank determination unit 126 may determine the customer rank based on one or more combinations of various information included in these customer information.

The electric power control unit 127 in the electric power control device 120 controls the maximum electric power consumption of the charger 110 when the customer uses the charging service based on the electric power unit price of electric power, the customer rank of the customer, and the electric power control policy. Specifically, the electric power control unit 127 refers to the electric power unit price information storage unit 123 and acquires the electric power unit price in the time zone in which the charging service is provided to the customer identified by the customer identification information. The electric power control unit 127 notifies the charger 110 of the maximum electric power consumption obtained by applying the acquired electric power unit price and the customer rank determined by the customer rank determination unit 126 to the electric power control policy stored in the electric power control policy storage unit 124.

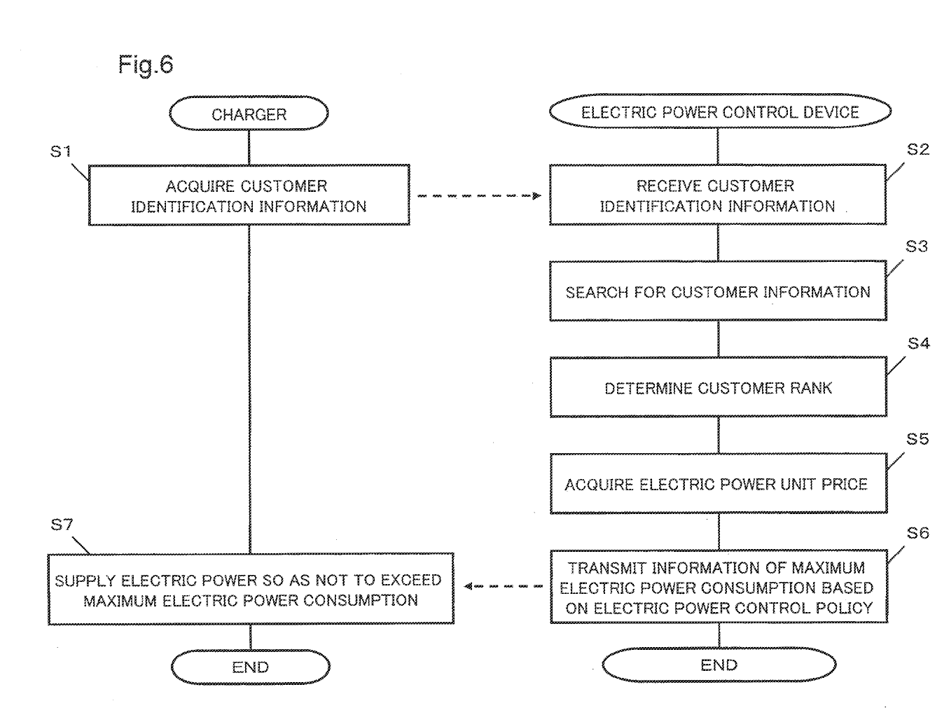

The operation of the charging system 100 having the above-mentioned configuration will be described with reference to FIG. 6. In FIG. 6, the operation of the charger 110 is illustrated in the left side of FIG. 6 and the operation of the electric power control device 120 is illustrated in the right side of FIG. 6. An arrowed broken line illustrated in FIG. 6 illustrates a flow of data between the devices. It is assumed that the customer information storage unit 121, the electric power unit price information storage unit 123, and the electric power control policy storage unit 124 of the electric power control device 120 store the predetermined information. Further, it is assumed that the charge interface 111 of the charger 110 is connected to the electric vehicle by the customer which requests the use of the charging system 100 by the charging cable or the like.

First, the control unit 115 of the charger 110 transmits the customer identification information inputted to the input interface 113 by the customer which requests the use of the charging system 100 to the electric power control device 120 via the communication interface 112 (Step S1). At this time, the control unit 115 may further transmit information such as the required electric power, the required electric power amount, and the like that are acquired from the electric vehicle via the charge interface 111 to the electric power control device 120.

The customer identification information acquisition unit 125 of the electric power control device 120 receives the information including the customer identification information of the customer (Step S2).

Next, the customer rank determination unit 126 searches for the customer information of the customer identified by the customer identification information received in Step S2 in the customer information storage unit 121 (Step S3).

Next, the customer rank determination unit 126 determines the customer rank of the customer based on the customer information searched for in Step S3 (Step S4).

Next, the electric power control unit 127 refers to the electric power unit price information storage unit 123 and acquires the electric power unit price in the time zone in which the charging service is provided to this customer (Step S5). At this time, when the electric power control unit 127 receives the information such as the electric power required for charging, the required electric power amount, and the like in Step S2, the electric power control unit 127 may calculate the time zone in which the charging service is provided to this customer based on these information and the current time.

Next, the electric power control unit 127 refers to the electric power control policy storage unit 124 and acquires a value of the maximum electric power consumption according to the customer rank of the customer determined in Step S4 and the electric power unit price acquired in Step S5. The electric power control unit 127 transmits the value of the maximum electric power consumption to the charger 110 (Step S6).

In the charger 110 which receives the value of the maximum electric power consumption from the power controller 127, the control unit 115 controls the charge interface 111 so as not to exceed the maximum electric power consumption that is received and supplies the electric power to the storage battery (Step S7).

Here, when the charging of the storage battery is completed, with respect to this charging of the storage battery, the control unit 115 may transmit information indicating the usage situation of the customer to the electric power control device 120. In this case, the electric power control device 120 may update the customer information storage unit 121 according to the reception of the information indicating the usage situation of the customer.

When the above-mentioned operation is completed, the operation of the charging system 100 ends.

Next, the effect of the first exemplary embodiment of the present invention will be described.

The charging system according to the first exemplary embodiment of the present invention can improve the satisfaction of the charging service provider and the satisfaction of the customer simultaneously.

That is because when the customer identification information acquisition unit acquires the customer identification information of the customer which requests the use of the charging service, the customer rank determination unit determines the customer rank based on the customer information of the customer. Further, the electric power control unit refers to the electric power control policy and controls the charger so as to charge the storage battery with the maximum electric power consumption that according to the electric power unit price of the electric power in the time zone in which the charging service is provided to the customer and the customer rank of the customer.

For example, when the high electric power unit price is applied to the customer whose rank is not high, the maximum electric power consumption of the charger is set to low for the same customer. Whereby, this contributes to the electric power management in the area and the satisfaction of the charging service provider can be improved. Further, it is expected that the customer whose rank is not high takes an action to move up the customer rank by increasing the number of use times of the charging service for storage battery and the service related to it or performing another action. As a result, the charging time of the storage battery is reduced for the customer which takes the action to move up the customer rank. Accordingly, when a setting in which when the high electric power unit price is applied to the customer whose rank is not high, the maximum electric power consumption of the charger is set to low for the same customer is used, as a result, the satisfaction of the customer can be improved. Further, when the high electric power unit price is applied to the customer whose rank is not high, the maximum electric power consumption of the charger is set to low for the same customer. This motivates the customer to take an action to move up the customer rank. Therefore, it is expected that the earning of the charging service provider increases and the satisfaction of the charging service provider is improved. Even when the high electric power unit price is applied to the customer whose rank is high, the maximum electric power consumption of the charger is set to high for the same customer. This reduces the charging time and the satisfaction of the customer can be improved. Further, because the customer satisfaction of such customer whose rank is high is improved, it is expected that the number of use times of the charging service and the service related to it and the purchased amount increase. Whereby, it can be expected that the charging service provider can get sufficient profit and thereby pay the electricity expense. Accordingly, when a setting in which when the high electric power unit price is applied to the customer whose rank is high, the maximum electric power consumption of the charger is set to high for the same customer is used, as a result, the satisfaction of the charging service provider can be improved.

Thus, in the charging system according to this exemplary embodiment, the maximum electric power consumption of the charger is controlled based on the electric power control policy which determines that when the electric power unit price is high and the customer rank is low, the maximum electric power consumption of the charger is set to low and when the electric power unit price is low and the customer rank is high, the maximum electric power consumption of the charger is set to high. Whereby, the satisfaction of the charging service provider and the satisfaction of the customer can be balanced.

Further, in this exemplary embodiment, the customer information storage unit may acquire the customer information from a server which manages a master of the customer information and hold the customer information synchronized with the master. In this case, the customer information storage unit may transmit the customer information updated based on the usage situation of the customer to the server. Such server may be connected to another charging system installed at another service station, another shopping center, or the like in the same manner.

In the explanation described above, the charging system according to this exemplary embodiment charges the storage battery mounted on the electric vehicle. However, the charging system according to this exemplary embodiment can be applied to a charging system which charges the storage battery installed in another equipment.

### Second Exemplary Embodiment

Next, a second exemplary embodiment of the present invention will be described in detail with reference to the drawing. In this exemplary embodiment, an example of the minimum configuration of the electric power control device of the present invention will be described. Further, in each drawing referred to in the description of the exemplary embodiment, the same reference numbers are used for the elements and the steps which perform the same operation as those of the first exemplary embodiment of the present invention and the description of the element and the operation of the step will be omitted.

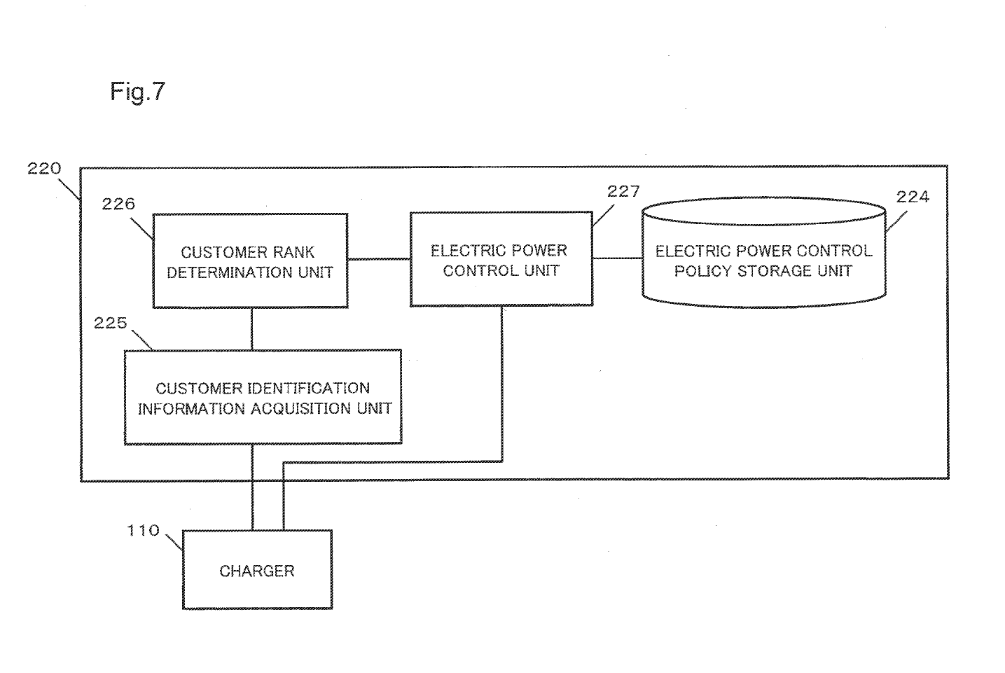

First, a functional block configuration of an electric power control device 220 according to the second exemplary embodiment of the present invention is illustrated in FIG. 7. In FIG. 7, the electric power control device 220 includes an electric power control policy storage unit 224, a customer identification information acquisition unit 225, a customer rank determination unit 226, and an electric power control unit 227. Further, the electric power control device 220 is connected to the charger 110 via the network interface like the electric power control device 120 according to the first exemplary embodiment of the present invention.

The electric power control policy storage unit 224 stores the electric power control policy in which the maximum electric power consumption of the charger 110 is determined according to the customer rank of the customer and the electric power unit price of the electric power. Here, the customer rank is information indicating the degree of priority of the customer which uses the charging service in which the storage battery is charged by the charger 110. Further, the electric power unit price is information indicating the electric power unit price specified by the time zone.

The customer identification information acquisition unit 225 acquires the customer identification information which identifies the customer which requests the use of the charging service. Specifically, the customer identification information acquisition unit 225 may acquire the customer identification information of the customer which requests the use of the charging service from the charger 110 like the customer identification information acquisition unit 125 according to the first exemplary embodiment of the present invention. Further, the customer identification information acquisition unit 225 may acquire the customer information of the customer concerned together with the customer identification information. Such customer information may include the information indicating the customer rank of the customer concerned. Alternatively, such customer information of the customer may include the information indicating a usage history of the charging service.

The customer rank determination unit 226 determines the customer rank of the customer based on the customer information about the customer identified by the customer identification information. For example, when the customer rank determination unit 226 acquires the customer information together with the customer identification information, the customer rank determination unit 226 may acquire the information indicating the customer rank of the customer included in the customer information. Alternatively, the customer rank determination unit 226 may determine the customer rank based on the information indicating the usage history of the charging service included in the customer information. Further, when the information indicating the customer rank and the information indicating the usage history are not included in such customer information, the customer rank determination unit 226 may determine a predetermined customer rank (for example, the customer rank with the lowest priority). Alternatively, the customer rank determination unit 226 is connected to an external server which receives customer identification information and sends back the customer rank via the network and the customer rank determination unit 226 determines the customer rank.

The electric power control unit 227 controls the maximum electric power consumption of the charger 110 based on the electric power unit price of the electric power in the time zone in which the charging service is provided to the customer identified by the customer identification information of the customer, the customer rank of the customer, and the electric power control policy when the charging service is provided to the customer. For example, the electric power control unit 227 may store the electric power unit price of the electric power for each time zone in advance and acquire the electric power unit price of the electric power in the time zone in which the charging service is provided to the customer. The electric power control unit 227 applies the electric power control policy stored in the electric power control policy storage unit 224 to the electric power unit price and the customer rank of the customer determined by the customer rank determination unit 226, determines the maximum electric power consumption, and notifies the charger 110.

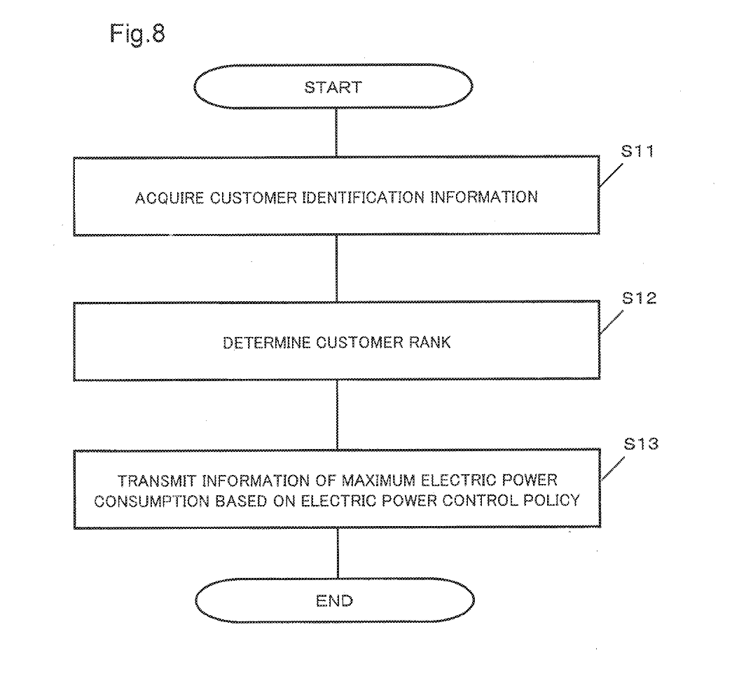

The operation of the electric power control device 220 which has the above-mentioned configuration will be described with reference to FIG. 8.

Further, it is assumed that the electric power control policy has already been stored in the electric power control policy storage unit 224 of the electric power control device 220. Further, it is assumed that the storage battery is connected to the charger 110 by the charging cable or the like by the customer which requests the use of the charging service.

First, the customer identification information acquisition unit 225 acquires the information including the customer identification information (Step S11).

Next, the customer rank determination unit 226 determines the customer rank of the customer identified by the customer identification information of the customer that is acquired in Step S11 (Step S12).

Next, the electric power control unit 227 applies the electric power control policy stored in the electric power control policy storage unit 224 to the electric power unit price of the electric power in the time zone in which the charging service will be provided to this customer and the customer rank of the customer determined in Step S12 and acquires a value of the maximum electric power consumption. The electric power control unit 227 transmits the value of the maximum electric power consumption to the charger 110 (Step S 13).

When the above-mentioned process is performed, the operation of the electric power control device 220 ends.

Next, the effect of the second exemplary embodiment of the present invention will be described.

The electric power control device according to the second exemplary embodiment of the present invention can improve the satisfaction of the charging service provider and the satisfaction of the customer simultaneously.

That is because when the customer identification information acquisition unit acquires the customer identification information of the customer which requests the use of the charging service, the customer rank determination unit determines the customer rank of the customer and the electric power control unit refers to the electric power control policy and controls the charger so that the storage battery is charged at the power of the maximum electric power consumption according to the electric power unit price of the electric power in the time zone in which the charging service is provided to the customer and the customer rank of the customer.

Further, in each exemplary embodiment of the present invention mentioned above, the operation of the electric power control device explained by referring to FIG. 6 and FIG. 8 may be realized by a CPU. In this case, a computer program of the present invention is stored in the storage device 14 (the storage medium 17) of a computer (FIG. 9), read out by the CPU, and executed by the CPU. In such case, a code of which the computer program is composed or a non-volatile storage medium storing the computer program is included in the present invention.

The present invention is not limited to the above-mentioned exemplary embodiment and can be performed in the various modes.

The invention of the present application has been described above with reference to the exemplary embodiment (and example). However, the invention of the present application is not limited to the above mentioned exemplary embodiment (and example). Various changes in the configuration or details of the invention of the present application that can be understood by those skilled in the art can be made without departing from the scope of the invention of the present application.

This application claims priority based on Japanese Patent Application No. 2012-114486 filed on May 18, 2012, the disclosure of which is hereby incorporated by reference in its entirety.

### REFERENCE SIGNS LIST

11 CPU
12 RAM
13 ROM
14 storage device
15 network interface
16 drive device
17 storage medium
18 bus
100 charging system
110 charger
111 charge interface
112 communication interface
113 input interface
114 display interface
115 control unit
120 and 220 electric power control device
121 customer information storage unit
122 electric power unit price information acquisition unit
123 electric power unit price information storage unit
124 and 224 electric power control policy storage unit
125 and 225 customer identification information acquisition unit
126 and 226 customer rank determination unit
127 and 227 electric power control unit

1. An electric power control device comprising:
an electric power control policy storage unit which stores an electric power control policy in which the maximum electric power consumption of a charger is determined according to a customer rank indicating a degree of priority of a customer which uses a charging service in which a storage battery is charged by the charger and an electric power unit price specified by a time zone;
a customer identification information acquisition unit which acquires customer identification information by which the customer which requests the use of the charging service is identified;
a customer rank determination unit which determines the customer rank of the customer based on customer information about the customer identified by the customer identification information; and
an electric power control unit which controls the maximum electric power consumption of the charger when providing the charging service to the customer based on the electric power unit price in the time zone in which the charging service is provided to the customer identified by the customer identification information, the customer rank of the customer identified by the customer identification information, and the electric power control policy.

2. The electric power control device according to claim 1, wherein the electric power control unit controls the maximum electric power consumption of the charger by using the electric power control policy in which when the electric power unit price is high and the customer rank is low, the maximum electric power consumption of the charger is set to low and when the electric power unit price is low and the customer rank is high, the maximum electric power consumption of the charger is set to high.

3. The electric power control device according to claim 1, further comprising:
a customer information storage unit which stores the customer information about the customer of the charging service in which the storage battery is charged by using the charger;
an electric power unit price information acquisition unit which acquires the time zone and electric power unit price information including the electric power unit price in the time zone; and
an electric power unit price information storage unit which stores the electric power unit price information,
wherein the customer information storage unit stores information related to a usage situation at the time when the customer used the charging service or the service related to it in the past, and
wherein the customer rank determination unit determines the customer rank so as to indicate a good customer degree of the customer based on at least the information related to the usage situation of the customer.

4. The electric power control device according to claim 3,
wherein the customer information storage unit stores information related to one or more of a purchase price when the customer has used the charging service or the service related to it in the past, the number of use times, the number of points given by the provider of the charging service or the service related to it, and a flag of shareholder which indicates whether or not the customer is a shareholder holding a share related to a provider of the charging service or the service related to it, and
wherein the customer rank determination unit determines the customer rank based on information related to one or more of the purchase price of the customer, the number of use times, the number of points, and the flag of shareholder.

5. The electric power control device according to claim 1, wherein the customer rank determination unit differentiates the customer rank determined based on the customer information for each time zone.

6. (canceled)

7. An electric power control method comprising:
storing an electric power control policy in which the maximum electric power consumption of a charger is determined according to a customer rank indicating a degree of priority of a customer which uses a charging service in which a storage battery is charged by a charger and an electric power unit price specified by a time zone;
acquiring customer identification information by which the customer which requests the use of the charging service is identified;
determining the customer rank of the customer based on customer information about the customer identified by the customer identification information; and
controlling the maximum electric power consumption of the charger when providing the charging service to the customer based on the electric power unit price in the time zone in which the charging service is provided to the customer identified by the customer identification information, the customer rank of the customer identified by the customer identification information, and the electric power control policy.

8. The electric power control method according to claim 7, which comprises controlling the maximum electric power consumption of the charger by using the electric power control policy in which when the electric power unit price is high and the customer rank is low, the maximum electric power consumption of the charger is set to low and when the electric power unit price is low and the customer rank is high, the maximum electric power consumption of the charger is set to high.

9. A non-transitory storage medium for recording a computer program to allow a computer device to perform: by using an electric power control policy storage unit which stores an electric power control policy in which the maximum electric power consumption of a charger is determined according to a customer rank indicating a degree of priority of a customer which uses a charging service in which a storage battery is charged by the charger and an electric power unit price specified by a time zone,
a customer identification information acquisition step acquiring customer identification information by which the customer which requests the use of the charging service is identified;
a customer rank determination step determining the customer rank of the customer based on customer information about the customer identified by the customer identification information; and
an electric power control step controlling the maximum electric power consumption of the charger when providing the charging service to the customer based on the electric power unit price in the time zone in which the charging service is provided to the customer identified by the customer identification information, the customer rank of the customer identified by the customer identification information, and the electric power control policy.

10. The non-transitory storage medium according to claim 9, wherein the electric power control step includes controlling the maximum electric power consumption of the charger by referring to the electric power control policy in which when the electric power unit price is high and the customer rank is low, the maximum electric power consumption of the charger is set to low and when the electric power unit price is low and the customer rank is high, the maximum electric power consumption of the charger is set to high.

11. An electric power control device comprising:
an electric power control policy storage means for storing an electric power control policy in which the maximum electric power consumption of a charger is determined according to a customer rank indicating a degree of priority of a customer which uses a charging service in which a storage battery is charged by the charger and an electric power unit price specified by a time zone;
a customer identification information acquisition means for acquiring customer identification information by which the customer which requests the use of the charging service is identified;
a customer rank determination means for determining the customer rank of the customer based on customer information about the customer identified by the customer identification information; and
an electric power control means for controlling the maximum electric power consumption of the charger when providing the charging service to the customer based on the electric power unit price in the time zone in which the charging service is provided to the customer identified by the customer identification information, the customer rank of the customer identified by the customer identification information, and the electric power control policy.
